(19) United States
(12) Patent Application Publication
(10) Pub. No.: US 2022/0076343 A1
(43) Pub. Date: Mar. 10, 2022

(54) SYSTEM AND METHOD FOR FOCUSED CROWDSOURCED INFORMATION

(71) Applicant: CrowdSense, LTD., London (GB)

(72) Inventors: Seth WARD, London (GB); Louis-Stephane LEGRAND, London (GB)

(21) Appl. No.: 17/469,299

(22) Filed: Sep. 8, 2021

Related U.S. Application Data
(60) Provisional application No. 63/075,659, filed on Sep. 8, 2020.

(51) Int. Cl. G06Q 40/06; G06N 20/10; G06N 20/20; G06N 3/08

(52) U.S. Cl. CPC G06Q 40/06; G06N 3/08; G06N 20/20; G06N 20/10

(57) ABSTRACT

A system and method for analyzing crowdsourced information to locate one or more informational signals.

### FIELD OF THE INVENTION

The present invention is of a system and method for analyzing crowdsourced information and in particular, to such a system and method for locating one or more informational signals within such crowdsourced information.

### BACKGROUND OF THE INVENTION

It is well known that individuals—whether amateurs or professional fund managers—cannot outperform the market over a consistent period of time. In addition, individuals often bring extensive biases to their market judgements. Retail investors pay high fees for a poor product in terms of advice, while the fund managers retain high profits. This system disadvantages retail investors, who do not have access to very expensive information and advice. Furthermore, even if expert advice is sought from multiple sources, it can be very difficult to combine different sources of such advice to a single decision. Expert advice from a single source is subject to the previously described biases.

### BRIEF SUMMARY OF THE INVENTION

The present invention overcomes these drawbacks of the background art by providing a system and method for analyzing crowdsourced information to locate one or more informational signals. For example and without limitation, the system preferably comprises an AI engine for applying one or more AI models and/or machine learning algorithms to the crowdsourced information, to compare one or more predictions made through such information to one or more outcomes. The AI engine may then be able to locate one or more subsets of crowd members who are able to make more accurate predictions. Preferably, the AI engine is also able to further determine which subsets of crowd members perform better in terms of prediction on particular types or categories of problems. A crowd member may belong to more than one subset, and/or may belong to a subset for one type or category of problems, but not for another type or category of problems.

Optionally any suitable AI engine or algorithm may be used, including but not limited to any one or more of random forest, CNN (convolutional neural network), SVM (support vector machine), linear regression, transformer (encoder/decoder), and DBN (Deep Belief Network). Other suitable models may also be included.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Unless otherwise defined, all technical and scientific terms used herein have the same meaning as commonly understood by one of ordinary skill in the art to which this invention belongs. The materials, methods, and examples provided herein are illustrative only and not intended to be limiting.

An algorithm as described herein may refer to any series of functions, steps, one or more methods or one or more processes, for example for performing data analysis.

Implementation of the apparatuses, devices, methods and systems of the present disclosure involve performing or completing certain selected tasks or steps manually, automatically, or a combination thereof. Specifically, several selected steps can be implemented by hardware or by software on an operating system, of a firmware, and/or a combination thereof. For example, as hardware, selected steps of at least some embodiments of the disclosure can be implemented as a chip or circuit (e.g., ASIC). As software, selected steps of at least some embodiments of the disclosure can be implemented as a number of software instructions being executed by a computer (e.g., a processor of the computer) using an operating system. In any case, selected steps of methods of at least some embodiments of the disclosure can be described as being performed by a processor, such as a computing platform for executing a plurality of instructions.

Software (e.g., an application, computer instructions) which is configured to perform (or cause to be performed) certain functionality may also be referred to as a “module” for performing that functionality, and also may be referred to a “processor” for performing such functionality. Thus, processor, according to some embodiments, may be a hardware component, or, according to some embodiments, a software component.

Further to this end, in some embodiments: a processor may also be referred to as a module; in some embodiments, a processor may comprise one or more modules; in some embodiments, a module may comprise computer instructions—which can be a set of instructions, an application, software—which are operable on a computational device (e.g., a processor) to cause the computational device to conduct and/or achieve one or more specific functionality. Some embodiments are described with regard to a “computer,” a “computer network,” and/or a “computer operational on a computer network.” It is noted that any device featuring a processor (which may be referred to as “data processor”; “pre-processor” may also be referred to as “processor”) and the ability to execute one or more instructions may be described as a computer, a computational device, and a processor (e.g., see above), including but not limited to a personal computer (PC), a server, a cellular telephone, an IP telephone, a smart phone, a PDA (personal digital assistant), a thin client, a mobile communication device, a smart watch, head mounted display or other wearable that is able to communicate externally, a virtual or cloud based processor, a pager, and/or a similar device. Two or more of such devices in communication with each other may be a “computer network.”

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the drawings:

FIG. 1 shows a non-limiting exemplary system for determining predictions or signals from a plurality of user based inputs;

FIG. 2 shows a detailed, non-limiting exemplary system for determining predictions or signals from a plurality of user based inputs;

FIGS. 3A to 3C relate to non-limiting exemplary devices for deploying various types of AI models alone or in combination;

FIG. 4 shows a non-limiting, exemplary method for creating informational and/or predictive subsets of users, which may also then be used to retrain an AI model;

FIGS. 5 and 6 relate to non-limiting exemplary methods for training AI models; and

FIG. 7 shows a non-limiting exemplary method for predicting economic outcomes and trading financial instruments according to at least some embodiments.

### DESCRIPTION OF AT LEAST SOME EMBODIMENTS

According to at least some embodiments, the system and method of the present invention are suitable for a variety of applications. A non-limiting example of such an application is for investment decision making, including without limitation for investing in an existing firm or for a startup. Non-limiting examples of information received may relate to the prediction field of the company, financial history to date, industry, geographic location, previous successes, and other corporate and execution history by executives, current partners and backers, technology evaluation, funding trajectory, current investment offer being made, sentiment analysis (with regard to the company and/or its executive(s)), competition analysis, media analysis, PEST (political, economic, social and technological trend) analysis; current clients, sales and traction; financial plans and projections.

Another non-limiting example is for the selection and purchase of financial instruments (stocks, bonds, shares, equities, DeFi pools and other forms of such instruments). Optionally such a purchase may be evaluated in terms of the investment behaviors and/or predictions of a group of individuals, potentially without a direct question being put to these individuals.

Yet another non-limiting example is for allocation of resources, for example to determine whether to invest in machinery, equipment, physical plant, human resources, and/or to expand or enter a product range, and/or to deploy resources in particular geographic areas. Such allocation may relate to balance of risks, decreasing a risk profile, or to take advantage of opportunities. Optionally such allocation is performed by government or other institutions.

Another non-limiting example is for the prediction of recruitment outcomes, with regard to the success of a particular candidate for a particular role and/or in a particular company.

Another non-limiting example is for sports and other event outcome prediction, for example for human-led events and/or for disaster outcome prediction.

Another non-limiting example is for verifying likely factual correctness of an article, press release or other news, including without limitation on social media.

Another non-limiting example is for predicting the level of impact and the likelihood of success of a medicine or other therapeutic treatment, or for a technological innovation, including without limitation for the subject invention in a patent/application.

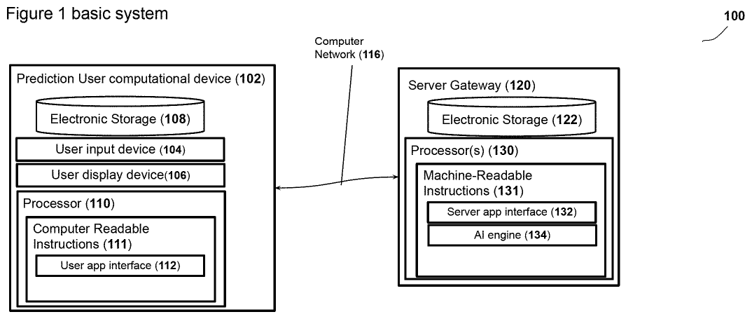

FIG. 1 shows a non-limiting exemplary system for determining predictions or signals from a plurality of user based inputs. As shown in FIG. 1 there is provided a system 100, for predicting one or more insights or actions according to a plurality of prediction user inputs. One prediction user computational device 102 is shown for the purpose of illustration only without intending to be limiting as a plurality of such prediction user computational devices may be used. Prediction user computational device 102 communicates with a survey gateway 120 through a computer network 116 as shown. Prediction user computational device 102 includes computer readable instructions 111, which are executed by a processor 110, for example, to execute user app interface 112. User app interface 112 accepts instructions from the user, for example, through user input device 104 or user display device 106. Information that the user inputs or other necessary data may be stored in electronic storage 108. A user, through prediction user computational device 102 and through user app interface 112 makes their prediction which is then sent to server gateway 120. This prediction, optionally with a plurality of additional predictions, is analyzed by an AI engine 134. A server interface 132 receives the instructions information and may also communicate and send instructions back to prediction user computational device 102, for example, with the next desired prediction to be made. Preferably server gateway 120 features a processor 130 and a machine readable instructions 131 for executing server app interface 132 and AI engine 134. Data such as predictions or other information may be stored in electronic storage 122.

Prediction user computational device 102 also comprises processor 110 and memory 111 as noted above. Functions of processor 110 preferably relate to those performed by any suitable computational processor, which generally refers to a device or combination of devices having circuitry used for implementing the communication and/or logic functions of a particular system. For example, a processor may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processor may further include functionality to operate one or more software programs based on computer-executable program code thereof, which may be stored in a memory, such as a memory 111 in this non-limiting example. As the phrase is used herein, the processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Also optionally, memory 111 is configured for storing a defined native instruction set of codes. Processor 110 is configured to perform a defined set of basic operations in response to receiving a corresponding basic instruction selected from the defined native instruction set of codes stored in memory 111. For example and without limitation, memory 111 may store a first set of machine codes selected from the native instruction set for receiving information from the user through user app interface 104 and a second set of machine codes selected from the native instruction set for transmitting such information to server gateway 120 as crowdsourced information.

Similarly, server gateway 120 preferably comprises processor 130 and memory with machine readable instructions 131 with related or at least similar functions, including without limitation functions of server gateway 120 as described herein. For example and without limitation, memory 131 may store a first set of machine codes selected from the native instruction set for receiving crowdsourced information from prediction user computational device 102, and a second set of machine codes selected from the native instruction set for executing functions of AI engine 134.

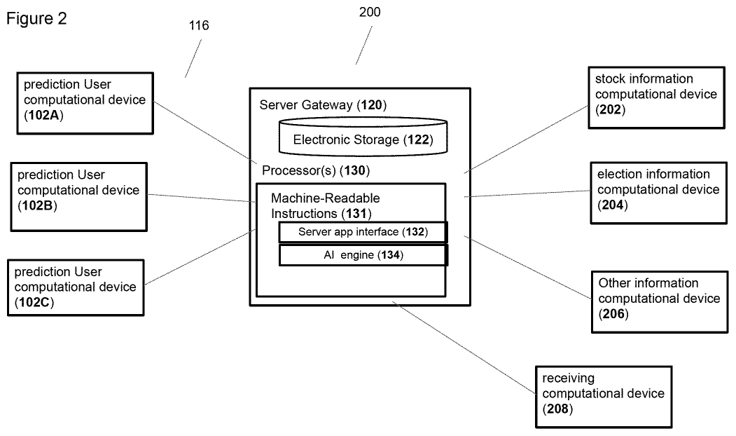

As shown now with regard to FIG. 2, there is provided a system 200. Components with the same reference number have the same or similar functions. A plurality of prediction user computational devices 102A 102B and 102C are shown. Server gateway 120 is also shown, communicating with prediction user computational devices 102A to 102C. The users through prediction user computational device 102 make predictions. This information is sent to server gateway 120 and it is analyzed by app engine 134 as previously described. A plurality of information sources are provided, shown as stock information computational device 202, election information computational device 204 and other information computation device 206. Other types of information may also be provided but are not shown for the sake of clarity. This information is sent to server gateway 120 through server app interface 132. This information may be initially processed by AI engine 134 before predictions requests are sent to prediction user computational devices 102A to 102C. Optionally as shown, a receiving user computational device 208 may receive the information from server gateway 120 through server app interface 134. This receiving computational device 208 may, for example, be a company which wishes to receive this information, a government function, a government entity, a not for profit, a hospital or indeed any other organization.

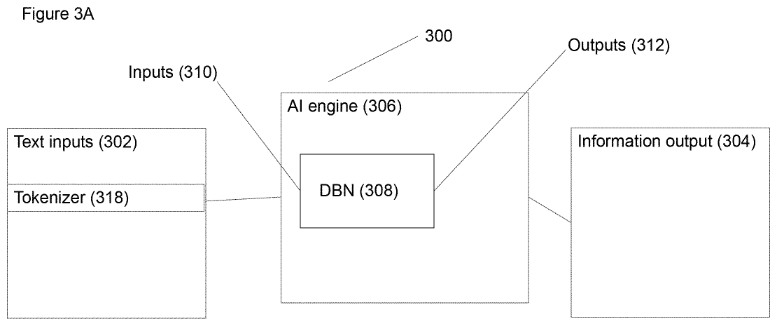

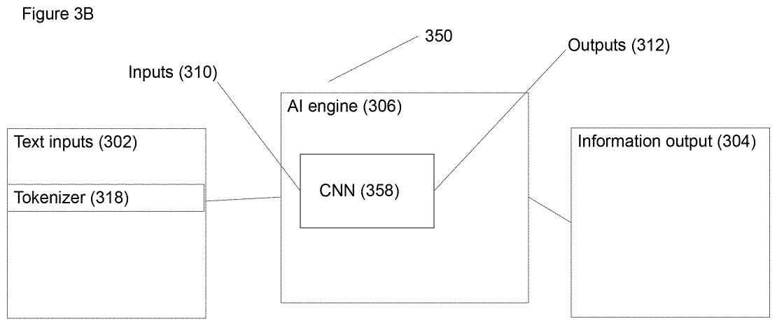

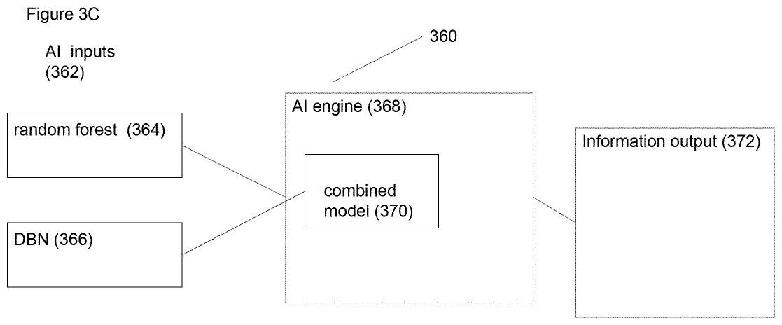

FIGS. 3A to 3C relate to non-limiting exemplary devices for deploying various types of AI models alone or in combination. As shown with regard to FIG. 3A there is provided a system 300 featuring text inputs 302 for natural language processing. Preferably these are textual inputs, but may also be voice inputs that are then converted to text. A tokenizer 318 may optionally perform some type of pre-processing on the input text. Additional types of pre-processing may be performed in place of or in addition to tokenization. Next, the input information is fed as inputs 310 to AI engine 306. Upon processing by AI engine 306, outputs 312 are then preferably provided as information output 304. Optionally, outputs 312 may be combined with a plurality of different outputs, and may further be processed to provide information output 304. In this non-limiting example, the neural net model provided with AI engine 306 comprises a DBN 308. A DBN is a deep belief network. A DBN is a type of neural network composed of multiple layers of latent variables (“hidden units”), with connections between the layers but not between units within each layer. Other types of models may be used in addition to or in place of the DBN and indeed may be combined with AI engine 306.

FIG. 3B shows another non-limiting exemplary system with an AI engine and model. Components with the same reference number have the same or similar function. In this non-limiting example of system 350, AI engine 306 comprises a CNN 358. A CNN is a convolutional neural net model. Again different types of models may be provided or combined.

A CNN is a type of neural network that features additional separate convolutional layers for feature extraction, in addition to the neural network layers for classification/identification. Overall, the layers are organized in 3 dimensions: width, height and depth. Further, the neurons in one layer do not connect to all the neurons in the next layer but only to a small region of it. Lastly, the final output will be reduced to a single vector of probability scores, organized along the depth dimension. It is often used for audio and image data analysis, but has recently been also used for natural language processing (NLP; see for example Yin et al, Comparative Study of CNN and RNN for Natural Language Processing, arXiv:1702.01923v1 [cs.CL] 7 Feb. 2017).

FIG. 3C relates to a system featuring a combination of different models of which two non-limiting examples are shown. In this non-limiting example, in the system 360 a plurality of AI inputs 362 are provided. As two non-limiting examples, these AI inputs include but are not limited to a random forest 364 and a DBN 366. The outputs of these AI models are then provided to AI engine 368 which in this case operates a combined model 370. Combined model 370 may feature any type of suitable ensemble learning method, including but not limited to, a Bayesian method, Bayesian optimization, a voting method, and the like. Additionally and alternatively, combined model 370 may feature one or more additional neural net models, such as for example, without limitation a CNN or an encoder decoder model. Transform models in general may also be used as part of the combined model 370. The output information is then provided as information output 372, which may, for example, comprise a plurality of different predictions and may also comprise different predictions from different subsets. Subsets of users may be selected in order to provide more accurate predictions with regard to particular ability on the part of those users to accurately predict an action, a function, an outcome or some other type of action.

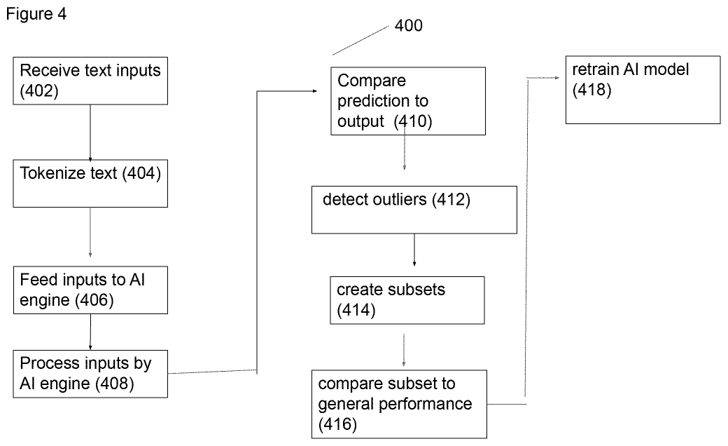

As a non-limiting example, as shown in FIG. 4, there is provided a method for creating such subsets, which may also then be used to retrain an AI model. As shown in the system 400, the method preferably starts by receiving text inputs at 402 from the users. These are then tokenized or otherwise pre-processed at 404. The inputs are fed to an AI engine at 406, as previously described. The AI engine may be any of the AI engines or models as described here in or a combination thereof. The inputs are processed by the AI engine at 408, which may feature a plurality of processing steps including, without limitation, employing a plurality of models together and or implying ensemble learning or a combined model as previously described. An output is provided by the AI engine which is then compared at 410. For example, the actual action or function may then be compared to the predictions. Various predictions may be compared within the output in order to determine what kind of prediction seems to be predominating and also to understand which users are outliers. The outliers have been detected at 412. So outlier detection may, for example, involve a less popular prediction or a prediction by a user that the user had not previously made or was not on trend for that particular user. Outlier detection may also relate to predictions that are against the received wisdom or some sort of underlying trend. The underlying trend may be fed from a data oracle or other data source of truth, which may be trusted, or which may at least be considered as a trusted oracle for providing such information.

Next, one or more subsets are created 414. The subsets may include outliers in some cases, and maybe prefer to go with the outliers, for example, to detect a black swan event, or other event which has a relatively low probability of occurring but a high possibility of causing damage if it does occur. The subsets may also relate to taking more popular positions. For example, maybe multiple users have a certain position and that may be useful as an output or as a subset. It may also be interesting to take a certain position with regard to geographic outputs. For example, what users are predicting in a certain geography as opposed to another geography. Subsets may be based on performance, demographics, geography, previous answers on trend answers and more. The subset is then compared to the general performance of 416 to determine whether a subset is more accurate at determining an answer or not. For example, a subset may comprise one or more super predictors. Optionally with the same or another subset, weaker signals from larger groups may be added. Such a combination may be created on a continuum, starting with a single predictor and continuing to one or more larger groups of predictors.

Then the AI model is retrained at 418 with the compared information. For example, certain subsets may be used to retrain a model or even train an entirely new model and that model may be used under certain circumstances for making predictions.

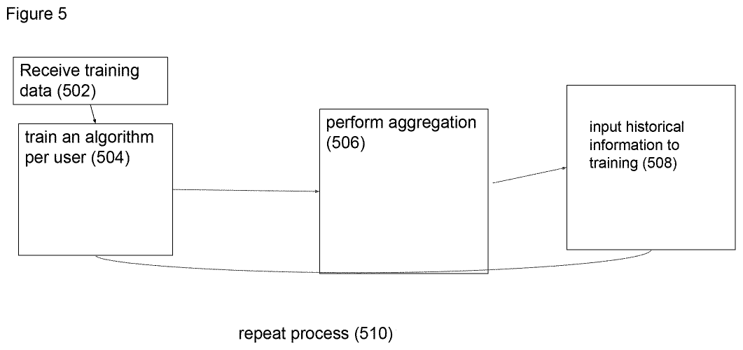

FIG. 5 relates to a non-limiting exemplary method for training an AI model. A method 500 preferably begins with receiving training data at 502, which may comprise any suitable training data as described herein. At 504, optionally for each user, an AI or ML algorithm is trained with information from that user. Such information may include but is not limited to the user's historical predictions and profile. The algorithm is preferably trained to remove bias.

At 506, aggregation is performed on the bias-reduced predictions of users by predefined clusters to obtain a history of such aggregated predictions. At 508, the history of aggregated predictions is preferably used for the input for training another AI/ML algorithm. Predictions by clusters are the learning variables.

At 510, optionally the above process is repeated, preferably with another model or combinations of AI/ML algorithms. Optionally multiple combinations are tested with multiple groups of users. Results may then be used to select the user(s) and/or groups of users as described above, to perform a particular prediction and/or analysis task.

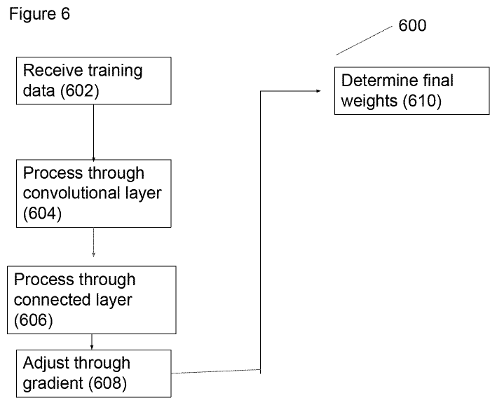

FIG. 6 relates to another non-limiting exemplary method for training an AI model, in this non-limiting example, a CNN. As shown with regard through flow 600, the training data is received in 602 and it is processed through the convolutional layer of the network in 604. This is if a convolutional neural net is used, which is the assumption for this non-limiting example. After that the data is processed through the connected layer in 606 and adjusted according to a gradient in 608. Typically, a steep descent gradient is used in which the error is minimized by looking for a gradient. One advantage of this is it helps to avoid local minima where the AI engine may be trained to a certain point but may be in a minimum which is local but it's not the true minimum for that particular engine. The final weights are then determined in 610 after which the model is ready to use.

In terms of provision of the training data, as described in greater detail above, preferably the training data is analyzed to clearly flag examples of bias, in order for the AI engine to be aware of what constitutes bias. During training, optionally the outcomes are analyzed to ensure that bias is properly flagged by the AI engine. Reduction of bias may for example comprise adjusting the output from the user to account for bias. In an extreme example, if a user is always wrong, then the AI engine could adjust the output by reversing a binary prediction and/or by indicating that the user prediction is wrong. For typical users with bias, the AI engine would need to weight or adjust the user prediction according to the estimated bias.

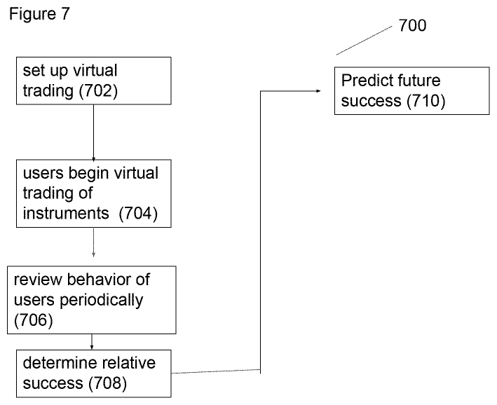

FIG. 7 shows a non-limiting exemplary method for predicting economic outcomes and trading financial instruments according to at least some embodiments. Optionally and preferably, multiple methods of collecting predictions and data from a crowd or plurality of individuals, and from third parties, are used to predict future events, including without limitation prices of financial instruments. Such financial instruments may include without limitation stocks, bonds, precious metals, indices, derivatives, commodities, and futures of any financial instrument.

Such collection of information may occur in the form of a game, such as a trading game for financial instruments, in addition to collecting formal predictions and forecasts regarding specific assets and events. Turning now to FIG. 7, as shown in a method 700, the method preferably starts with setting up virtual trading, by providing virtual finances and a plurality of financial instruments to a plurality of users, at 702. Next, the users begin trading the financial instruments at 704, based on their own available information and beliefs about future prices of these instruments. Over time, the behavior of such users in trading is preferably reviewed at 706. After each suitable period of time, at 708, preferably the behavior of the users and the relative success of their predictions with regard to actual market prices for the financial instruments are monitored. It is possible to monitor the success of a wide number of individual traders as well as across an almost unlimited number of assets. The period of time during which review occurs may be 1 day, 1 week, 1 month, 1 quarter, 1 half year, 1 year or any suitable period in between.

Using similar weighting and believability methods as described herein, it is possible to judge whether a particular investor (user) or asset (financial instrument) is likely to perform well in the future at 710. Such an investor or combination of investors, or assets or combination of assets, may then be traded on accordingly, for example and without limitation to help adjust the allocation between asset classes or individual investments, to time trades or some combination thereof.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A system for selecting a prediction signal from a plurality of prediction signals provided by a plurality of users, comprising a plurality of user computational devices, each user computational device comprising a user app; a server, comprising a server interface, a database for storing a plurality of decision histories from the plurality of users, and an AI (artificial intelligence) engine; and a computer network for connecting said user computational devices and said server; wherein each decision is provided through each user app and is analyzed by said AI engine, wherein said AI engine analyzes each decision history to determine each prediction signal and analyzes said plurality of decision histories to determine the selected prediction signal from said plurality of prediction signals.

2. The system of claim 1, wherein said server comprises a server processor and a server memory, wherein said server memory stores a defined native instruction set of codes; wherein said server processor is configured to perform a defined set of basic operations in response to receiving a corresponding basic instruction selected from said defined native instruction set of codes; wherein said server comprises a first set of machine codes selected from the native instruction set for receiving said decisions from said user computational device, and a second set of machine codes selected from the native instruction set for executing functions of said AI engine.

3. The system of claim 2, wherein each user computational device comprises a user processor and a user memory, wherein said user memory stores a defined native instruction set of codes; wherein said user processor is configured to perform a defined set of basic operations in response to receiving a corresponding basic instruction selected from said defined native instruction set of codes; wherein said user computational device comprises a first set of machine codes selected from the native instruction set for receiving said request through said user app, and a second set of machine codes selected from the native instruction set for transmitting said information to said server as said decision.

4. The system of claim 3, wherein said AI engine analyzes said plurality of prediction signals to determine an overall signal.

5. The system of claim 4, wherein said AI engine analyzes each of a plurality of sets of pluralities of prediction signals and determines an overall signal from said plurality of sets of prediction signals.

6. The system of claim 5, wherein said AI engine comprises deep learning and/or machine learning algorithms.

7. The system of claim 6, wherein said AI engine comprises an algorithm selected from the group consisting of random forest, CNN (convolutional neural network), SVM (support vector machine), linear regression, transformer (encoder/decoder), and DBN (Deep Belief Network).

8. A method for selecting a plurality of user predictors, comprising applying the system of claim 1, selecting a plurality of user predictions according to the above system and selecting the plurality of user predictors according to the plurality of user predictions.

9. The method of claim 8, further comprising reviewing the behavior of the plurality of user predictors in a virtual game for trading financial instruments.
